(19) United States
(12) Patent Application Publication
(10) Pub. No.: US 2020/0290401 A1
(43) Pub. Date: Sep. 17, 2020

(54) TIRE REINFORCED BY A CARBON STEEL STRIP

(71) Applicant: COMPAGNIE GENERALE DES ETABLISSEMENTS MICHELIN, Clermont-Ferrand (FR)

(72) Inventor: ARNAUD VERLEENE, Clermont-Ferrand (FR)

(21) Appl. No.: 16/062,765

(22) PCT Filed: Dec. 16, 2016
(86) PCT No.: PCT/FR2016/053484

§ 371 Date: Jun. 15, 2018

(30) Foreign Application Priority Data
Dec. 16, 2015 (FR) 1562495

(51) Int. Cl. B60C 9/00; C22C 38/00; C22C 38/04; C22C 38/02; C22C 38/06; C22C 38/18

(52) U.S. Cl. CPC B60C 9/0007; C22C 38/004; C22C 38/18; C22C 38/02; C22C 38/06; C22C 38/04

(57) ABSTRACT

A motor vehicle tire is reinforced by at least one carbon steel band that has a very low carbon content and high strength in the work-hardened state The carbon steel comprises (% by weight) between 0.05% and 0.4% of carbon, between 0.5% and 4% of manganese, between 0.1% and 2.5% of silicon, optionally (i) less than 1.5% of aluminium, (ii) less than 0.5% of each of the metals boron, chromium, cobalt, copper, molybdenum, nickel, niobium, titanium, tungsten, vanadium, and zirconium, and (iii) less than 0.05% of each of the elements phosphorus, sulfur, nitrogen, or rare earth, and the rest is made up of iron and inevitable impurities resulting from the smelting. The microstructure of the work-hardened carbon steel is mainly martensitic or ferritic-martensitic. The strength, denoted Rm, of the strip is greater than 1200 MPa and its elongation at break, denoted At, is between 1% and 5%.

### 1. FIELD OF THE INVENTION

The present invention relates to tyres for motor vehicles and to the metal reinforcers used for reinforcing such tyres.

It relates more particularly to the use, as reinforcing elements of these tyres, of metal bands made of carbon steel with a specific microstructure and good mechanical properties.

### 2. PRIOR ART

As is known, a tyre having a radial carcass reinforcement for a vehicle, for example of the passenger vehicle, van or heavy-duty vehicle type, to mention just a few examples, comprises a tread, two inextensible beads intended to be in contact with a mounting rim, two flexible sidewalls reinforced by the carcass reinforcement, connecting the beads to the tread, and a rigid crown reinforcement or “belt” disposed circumferentially between the carcass reinforcement and the tread, this belt being made up of various plies (or “layers”) of rubber that are reinforced or not by reinforcing elements (or “reinforcers”) such as cords or monofilaments, of the metal or textile type.

More specifically, the belt of a tyre is generally made up of at least two superimposed belt plies, sometimes referred to as “working plies” or “cross plies”, the reinforcing cords of which, generally in metal, are positioned virtually parallel to one another inside a ply, but crossed from one ply to the other, that is to say inclined, symmetrically or asymmetrically, with respect to the median circumferential plane, by an angle which is generally between 10° and 45°, depending on the type of tyre under consideration.

These working plies, it may be reminded, have the prime function of giving the tyre high drift thrust or cornering stiffness which, in a known manner, is necessary for achieving good road holding (“handling”) on the motor vehicles. They may be supplemented by various other auxiliary plies or layers of rubber, with widths that can vary as the case may be, comprising or not comprising reinforcers; mention will be made by way of example of simple rubber cushions, of plies referred to as “protective” plies which have the role of protecting the remainder of the belt from external attacks or perforations, or of plies referred to as “hooping” plies which contain reinforcers that are oriented substantially in the circumferential direction (plies referred to as “zero-degree” plies), whether these be radially on the outside or on the inside with respect to the cross plies.

This having been reminded, a tyre belt has to comply, in a known manner, with different, often contradictory, requirements, notably:
being as rigid as possible with little deformation, since it plays a substantial part in stiffening the crown of the tyre;
having the lowest possible hysteresis in order to minimize the heating of the internal region of the crown during running and also to reduce the rolling resistance of the tyre, this going hand in hand with saving fuel;
having high resistance to the mechanisms of corrosion fatigue associated with the risk of penetration of corrosive agents such as water or oxygen of the air through the tread, for example as a result of cuts, and the carrying thereof to the metal reinforcers of the belt;
and finally having high endurance, particularly with regard to the phenomenon of separation, cracking of the ends of the cross plies in the shoulder regions of the tyre, known as “belt separation”, which notably requires that the metal cords that reinforce the belt plies have high compression fatigue strength, all of this in a more or less corrosive environment.

The third and fourth requirements are particularly significant for example for tyre casings for heavy-duty vehicles, which are designed to be able to be retreaded one or more times when the treads that they comprise reach a critical level of wear after prolonged running.

Nowadays, the availability of steels with a high carbon content that are increasingly strong means that tyre manufacturers are increasingly tending, in a general manner, towards the use in belts of small cords with a very simple structure, notably having only two or three threads, or even of individual threads, in order to reduce the thickness of the reinforcing plies and thus the hysteresis of the tyres, and ultimately to reduce the energy consumption of the vehicles fitted with these tyres.

Such tyres with a belt of reduced thickness and hysteresis and reinforced by individual threads, notably for passenger vehicles or vans, have been described for example in the patent applications WO 2013/117476, WO 2013/117477, WO 2015/014574, WO 2015/014575 filed by the applicant.

These efforts that aim to reduce the weight of the tyres by reducing the thickness of their belt and of the layers of rubber of which it is made sometimes, of course, come up against certain physical limits, in particular a minimum envelope diameter of the cords or of the individual threads which has to remain relatively large in order to ensure sufficient mechanical strength and stiffness for the reinforcer and thus for the belt of the tyre.

One alternative to the use of small cords or individual threads, as above, could, of course, reside in the use of steel reinforcers having a high carbon content and high strength which are no longer in the form of threads but in the form of bands which, with the same weight, have a comparatively large width but a much smaller thickness: therefore, even smaller thicknesses for the layers of rubber coating these reinforcers could be targeted, without prohibitively penalizing the mechanical strength and the modulus of the reinforcers used.

However, during their research, the Applicants have found that the use of such bands can unexpectedly harm the endurance of the belt of the tyre, particularly with the abovementioned problem of separation.

### 3. BRIEF DESCRIPTION OF THE INVENTION

The subject of the present invention is a novel tyre, reinforced by a metal band made of carbon steel with a specific microstructure and good mechanical properties, said tyre having, by virtue of this band, significantly improved endurance, particularly with regard to the problem of belt separation, compared with the tyres reinforced with carbon steel bands known from the prior art. This specific band also gives the tyre of the invention improved resistance to corrosion fatigue.

Thus, according to a first subject, the present invention relates to a motor vehicle tyre comprising at least one carbon steel band that has a very low carbon content and high strength in the work-hardened state, characterized by the following points:
the carbon steel has (% by weight) between 0.05% and 0.4% of carbon, between 0.5% and 4% of manganese, between 0.1% and 2.5% of silicon, optionally (i) less than 1.5% of aluminium, (ii) less than 0.5% of each of the metals boron, chromium, cobalt, copper, molybdenum, nickel, niobium, titanium, tungsten, vanadium, zirconium, and (iii) less than 0.05% of each of the elements phosphorus, sulfur, nitrogen, or rare earth, the rest being made up of iron and inevitable impurities resulting from the smelting;
the microstructure of the work-hardened carbon steel is mainly martensitic or ferritic-martensitic;
the strength, denoted Rm, of the band is greater than 1200 MPa and its elongation at break, denoted At, is between 1% and 5%.

The above band, which has a specific microstructure, has the noteworthy properties of high mechanical strength, in spite of a very low carbon content, combined with improved resistance to the mechanisms of corrosion and corrosion fatigue.

The invention relates to tyres both in the uncured state (that is to say before curing or vulcanization of the rubber) and in the cured state (after curing of the rubber). The tyres of the invention may be intended, in particular, for motor vehicles of the passenger, 4×4 or “SUV” (Sport Utility Vehicle) type, but also for industrial vehicles chosen from vans, “heavy-duty” vehicles—i.e. underground trains, buses, heavy road transport vehicles (lorries, tractors, trailers), off-road vehicles—agricultural or civil engineering machines, aircraft and other transport or handling utility vehicles.

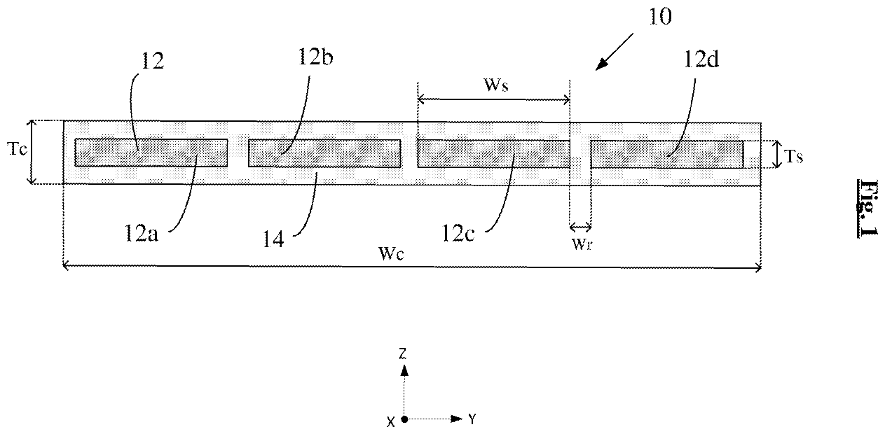

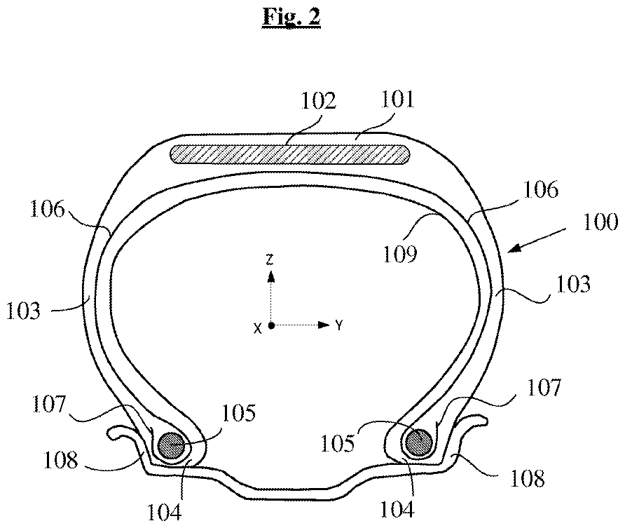

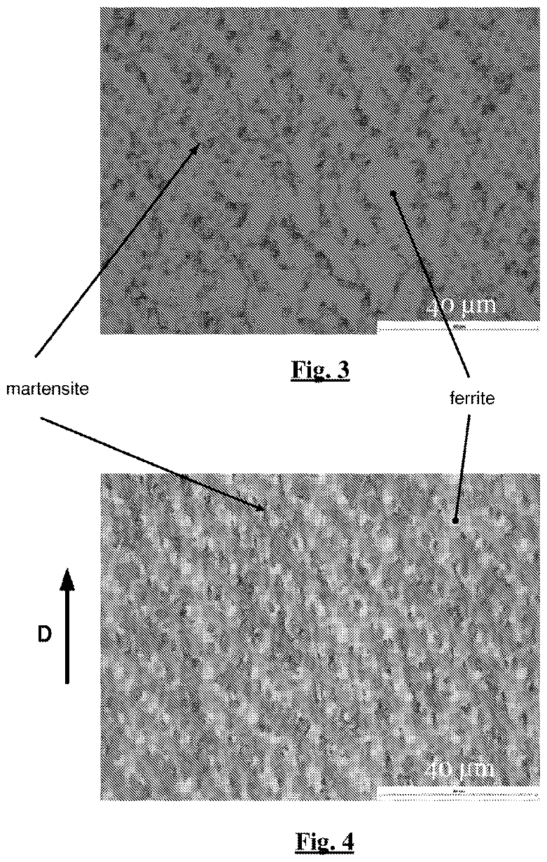

The invention and the advantages thereof will be readily understood in the light of the following detailed description and exemplary embodiments, and from FIGS. 1 to 4 which relate to these examples and schematically depict or reproduce:
in cross section, an example of a (metal/rubber) composite that is usable as reinforcing structure in the tyre according to the invention (FIG. 1);
in radial section (that is to say, in a plane containing the axis of rotation of the tyre), an example of a tyre according to the invention, incorporating a band and a metal/rubber composite suitable for the invention (FIG. 2);
an optical microscope view of a ferritic-martensitic microstructure observed on a steel band with a low carbon content of the dual-phase type that is able to reinforce the tyre of the invention, before (FIG. 3) and after work-hardening (FIG. 4) of this carbon steel.

### 4. DEFINITIONS

In the present application, terms are understood as follows:
“rubber” or “elastomer” (the two terms being considered to be synonymous): any type of elastomer, be it of the diene type or the non-diene type, for example thermoplastic;
“rubber composition” or “rubbery composition”: a composition which contains at least one rubber and one filler;
“layer”: a sheet, band or any other element of which the thickness is relatively small compared to its other dimensions, preferably in which the ratio of thickness to the largest of the other dimensions is less than 0.5, more preferably less than 0.1;
“axial direction”: a direction substantially parallel to the axis of rotation of the tyre;
“circumferential direction”: a direction which is substantially perpendicular both to the axial direction and to a radius of the tyre (in other words, tangential to a circle of which the centre lies on the axis of rotation of the tyre);
“radial direction”: a direction along a radius of the tyre, that is to say any direction that passes through the axis of rotation of the tyre and is substantially perpendicular to this direction, that is to say makes an angle of no more than 5 degrees with a perpendicular to this direction;
“oriented along an axis or in a direction”: when speaking of any element such as a reinforcer, an element which is oriented substantially parallel to this axis or this direction, that is to say makes an angle of no more than 5 degrees (and thus zero or at most equal to 5 degrees) with this axis or this direction;
“oriented perpendicularly to an axis or a direction”: when speaking of any element such as a reinforcer, an element which is oriented substantially perpendicularly to this axis or this direction, that is to say makes an angle of no more than 5 degrees with a perpendicular to this axis or this direction;
“median circumferential plane” (denoted M): the plane perpendicular to the axis Y of rotation of the tyre which is situated mid-way between the two beads and passes through the middle of the crown reinforcement or belt.

Unless expressly indicated otherwise, all the percentages (%) indicated in the present application are percentages by weight (or by mass, in an equivalent manner).

The expression “x and/or y” means “x” or “y” or both (i.e. “x and y”). Any range of values denoted by the expression “between a and b” represents the field of values ranging from more than “a” to less than “b” (that is to say limits “a” and “b” excluded), whereas any range of values denoted by the expression “from a to b” means the field of values ranging from “a” up to “b” (that is to say including the strict limits “a” and “b”).

### 5. DETAILED DESCRIPTION OF THE INVENTION

Therefore, the present invention relates to a tyre comprising, as metal reinforcer, a steel band that has a very low carbon content, specifically between 0.05% and 0.4% of carbon, also comprising between 0.5% and 4% of manganese, between 0.1% and 2.5% of silicon, optionally (i) less than 1.5% of aluminium, (ii) less than 0.5% of each of the metals boron, chromium, cobalt, copper, molybdenum, nickel, niobium, titanium, tungsten, vanadium, zirconium, and (iii) less than 0.05% of each of the elements phosphorus, sulfur, nitrogen, or rare earth, the rest being made up of iron and inevitable impurities resulting from the smelting.

The band is made of steel, that is to say that, by definition, it consists predominantly (for more than 50% by weight) or completely (for 100% by weight) of steel.

The steel is advantageously as defined in the NF EN10020 (September 2000) standard. In accordance with this standard, a steel is a material which contains more iron than any other element and the carbon content of which is less than 2%. Still in accordance with this standard, the steel optionally comprises other alloying elements.

Preferably, the carbon content of the carbon steel is in a range from 0.1 to 0.3%, more preferably in a range from 0.15% to 0.25%. Preferably, the manganese content thereof is in a range from 1% to 3%, more preferably in a range from 1.5% to 2.5%. According to another preferred embodiment, the silicon content thereof is between 0.1 and 1.5%, more preferably in a range from 0.2% to 1.0%, in particular in a range from 0.3% to 0.8%. The optional aluminium content thereof is preferably less than 1.0%, more preferably less than 0.5%.

Preferably, the content of each of the optional metals boron, chromium, cobalt, copper, molybdenum, nickel, niobium, titanium, tungsten, vanadium, zirconium, is less than 0.3%, more preferably less than 0.2%. The content of each of the elements phosphorus and sulfur is preferably less than 0.020%, more preferably less than 0.015%.

According to another essential feature of the invention, the microstructure of the carbon steel in the work-hardened state is mainly martensitic or mainly ferritic-martensitic, i.e. it is made up of more than 50% by volume either of martensite phases (in this case referred to as “mainly martensitic”) or of martensite and ferrite phases (in this case referred to as “mainly ferritic-martensitic”).

A person skilled in the art knows how to distinguish a martensitic or ferritic-martensitic microstructure from another microstructure, by metallographic observation. In a known manner, a martensitic or ferritic-martensitic microstructure has martensite laths or martensite laths combined with ferrite phases, respectively.

In the case of a microstructure of the martensitic type (preferably made up of more than 80% by volume of martensite phases), the percentage by volume of martensite is more preferably greater than 90%, in particular greater than 95%.

In the case of a microstructure of the ferritic-martensitic type (preferably made up of more than 80% by volume of martensite and ferrite phases), the total percentage by volume of martensite and ferrite is more preferably greater than 90%, in particular greater than 95%. Even more preferably, for such a microstructure, the content of ferrite itself is greater than 60%.

This volumetric content is determined in a known manner by image analysis, simply by measuring the area taken up by the martensitic phases, or martensitic and ferritic phases, and relating them to the total area of the image.

According to one particular embodiment, the carbon steel is a steel of the “TRIP” or “T” type (TRansformation Induced Plasticity); within the meaning of the NF EN 10338 (October 2015) standard, it is, for reminder, a steel having a mainly ferritic matrix containing residual austenite capable of being converted into martensite during the forming process.

According to another particular and preferred embodiment, the carbon steel is a steel of the “dual-phase” type; within the meaning of the abovementioned NF EN 10338 (October 2015) standard, it is a steel containing mainly ferrite and martensite and optionally bainite as complementary phase.

According to another particular and preferred embodiment, the carbon steel is a steel of the martensitic (“MS”) type; within the meaning of the NF EN 10338 (October 2015) standard, it is a steel with a martensitic matrix containing small quantities of ferrite and/or bainite.

A band “in the work-hardened state” (also known as a “cold-rolled” strip) is understood to be a band which has been cold rolled, i.e. which has not been subjected to any heat treatment regenerating its microstructure either during rolling or after rolling.

A further essential, and also unexpected, feature of the carbon steel band suitable for the tyre of the invention is that it has very high tensile strength in the work-hardened state, making it suitable, in the form of a band, to reinforce motor vehicle tyres. Its mechanical strength Rm is preferably greater than 1500 MPa, more preferably greater than 1800 MPa, even more preferably greater than 1900 MPa. Its total elongation at break At is preferably between 1% and 3%, more preferably in a range from 1.5 to 2.5%. The maximum tensile strength or ultimate tensile strength Rm corresponds to the force necessary to break the thread under tension; Rm (in MPa) and At (in % of the initial length before tension) are measured in accordance with the ISO 6892 standard of 1984, at ambient temperature (23° C.)

In order to obtain such a combination of microstructure and mechanical properties, it was necessary to roll the starting strips or bands with a very low carbon content as greatly by work-hardening them without intermediate heat treatment.

The thickness, denoted “Ts”, of the band is preferably less than 2 mm, more preferably less than 1 mm. Even more preferably, this thickness Ts is between 0.1 and 0.8 mm, in particular in a range from 0.15 to 0.5 mm, even more particularly in a range from 0.2 to 0.5 mm, even more particularly in a range from 0.25 to 0.45 mm or in a range from 0.15 to 0.35 mm. The width, denoted “Ws”, of this band is conventionally less than 50 mm, preferably less than 20 mm. Even more preferably, this width Ws is between 1 and 15 mm, more preferably greater than 1 mm and less than or equal to 10 mm, more particularly in a range from 2.5 to 10 mm, even more preferably from 2.5 to 5 mm.

Of course, the band may be coated with a layer of metal that improves for example the wear properties thereof, such as the properties of grip, corrosion resistance or resistance to ageing.

Thus, preferably, the band is coated with a layer of zinc or more preferably a layer of brass (alloy of copper and zinc) deposited, for example, electrolytically from brass anodes. The brass coating preferably has a very small thickness, much less than one micrometre, for example around 0.10 to 0.30 μm, this being negligible compared with the thickness of the band.

In a variant, the band could be covered with a metal layer other than brass or zinc, having for example the role of improving the corrosion resistance and/or the adhesion to the rubber, for example a thin layer of Co, Ni, Al, or an alloy of two or more of the compounds Cu, Zn, Al, Ni, Co and Sn. It is also possible for the band not to have any metal coating, i.e. to be made of what is known as “plain” steel.

In the tyre of the invention, the above-described band is typically incorporated into rubber in order to form a metal/rubber composite (10) comprising at least one such band (12), preferably a plurality thereof aligned in parallel (12a, 12b, 12c, 12d, etc.), coated with at least one layer (14) of rubber composition, notably diene rubber, such a composite being shown for example in FIG. 1.

The total thickness, denoted “Tc”, of the composite (measured in the direction Z) may vary widely depending on the particular applications targeted; it is preferably between 0.5 and 3.0 mm, more preferably between 0.5 and 1.5 mm. Preferably, notably when it is intended to be used as a reinforcing structure in the belt of the tyre of the invention, this composite has a width “Wc” (in the direction Y) and a length (in the direction X) which are greater than 2.5 mm and 10 cm, respectively, more preferably greater than 5 mm and 20 cm, respectively.

Each rubber composition making up the composite (metal/rubber) is based on at least one elastomer, preferably of the diene type. “Diene” rubber is understood, in a known manner, to be any elastomer (single elastomer or mixture of elastomers) which is derived, at least in part (i.e., a homopolymer or copolymer), from diene monomers, i.e. from monomers bearing two carbon-carbon double bonds, whether the latter are conjugated or not.

This diene elastomer is preferably selected from the group consisting of polybutadienes (BRs), natural rubber (NR), synthetic polyisoprenes (IRs), various butadiene copolymers, various isoprene copolymers and mixtures of these elastomers, such copolymers being notably selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

One particularly preferred embodiment consists in using an “isoprene” elastomer, that is to say an isoprene homopolymer or copolymer, in other words a diene elastomer selected from the group consisting of natural rubber (NR), synthetic polyisoprenes (IRs), various isoprene copolymers and mixtures of these elastomers. The isoprene elastomer is preferably natural rubber or a synthetic polyisoprene of the cis-1,4 type. Among these synthetic polyisoprenes, use is preferably made of polyisoprenes having a content (mol %) of cis-1,4 bonds of greater than 90%, even more preferably greater than 98%. According to one preferred embodiment, each layer of rubber composition contains 50 to 100 phr of natural rubber. According to other preferred embodiments, the diene elastomer may consist, in full or in part, of another diene elastomer such as, for example, an SBR elastomer used as a blend with another elastomer, for example of the BR type, or used alone.

The rubber composition may contain a single diene elastomer or several diene elastomers, the latter possibly being used in combination with any type of synthetic elastomer other than a diene elastomer, or even with polymers other than elastomers. The rubber composition may also comprise all or some of the additives customarily used in the rubber matrices intended for the manufacture of tyres, such as, for example, reinforcing fillers such as carbon black or silica, coupling agents, anti-aging agents, antioxidants, plasticizing agents or extender oils, whether the latter are of aromatic or non-aromatic nature, plasticizing resins with a high glass transition temperature, processing aids, tackifying resins, anti-reversion agents, methylene acceptors and donors, reinforcing resins, a crosslinking or vulcanization system.

Preferably, the system for crosslinking the rubber composition is a system referred to as a vulcanization system, that is to say one based on sulfur (or on a sulfur donor agent) and a primary vulcanization accelerator. Various known secondary vulcanization accelerators or vulcanization activators may be added to this basic vulcanization system. Sulfur is used at a preferred content of between 0.5 and 10 phr, and the primary vulcanization accelerator, for example a sulfenamide, is used at a preferred content of between 0.5 and 10 phr. The content of reinforcing filler, for example carbon black or silica, is preferably greater than 50 phr, in particular between 50 and 150 phr.

All carbon blacks, especially blacks of the HAF, ISAF or SAF type, conventionally used in tyres (“tyre-grade” blacks) are suitable as carbon blacks. Mention will more particularly be made, among the latter, of the carbon blacks of 300, 600 or 700 (ASTM) grade (for example, N326, N330, N347, N375, N683 or N772). Precipitated or fumed silicas having a BET surface area of less than 450 m²/g, preferably from 30 to 400 m²/g, are notably suitable as silicas.

A person skilled in the art will know, in light of the present description, how to adjust the formulation of the rubber composition in order to achieve the desired levels of properties (notably modulus of elasticity), and to adapt the formulation to the specific application envisaged.

According to one preferred embodiment, in the metal/rubber composite suitable for the tyre of the invention, the band is provided with an adhesive layer facing the rubber composition with which it is in contact.

As examples of adhesive layers other than metal coatings as described above, metal/rubber adhesive systems of the polymeric type, as described notably in the applications WO 2015/118040, WO 2015/118041, WO 2015/118042, WO 2015/118044, may notably be mentioned.

Of course, the invention also applies to cases in which an adhesive layer is not used, the band itself and/or the rubber composition being able to have a self-adhesive property on account of the particular formulation thereof.

A person skilled in the art will readily understand that the connection between the band and the rubber with which it is in contact will be definitively provided during the final curing (crosslinking) of the tyre of the invention.

This metal/rubber composite, which notably has improved resistance to corrosion and corrosion fatigue, makes it possible to advantageously replace the conventional fabrics or plies reinforced with threads or cords made of steel having a high carbon content.

It also has the advantage, by virtue of the small possible thickness of the bands of which it is made, of having low hysteresis compared with these conventional fabrics, thereby making it possible to further reduce the rolling resistance of the tyres.

Last but not least, this metal/rubber composite that is suitable for the tyre of the invention has demonstrated resistance to perforation that is notably improved compared with these same conventional fabrics reinforced with cords: for the same steel reinforcer weight, compared with a control fabric reinforced for example with a 4-thread steel cord (of construction 2+2), it has been found that the perforation of the fabric according to the invention, with the aid of an indenting tool with a diameter of 5.5 mm, required a force increased by 25%.

The rubber compositions used for these (metal/rubber) composites may be for example conventional compositions for the calendering of metal reinforcers, typically based on natural rubber, carbon black or silica, a vulcanization system and the usual additives.

Preferably, these rubber compositions have, in the crosslinked (vulcanized) state, a secant tensile modulus, at 10% elongation, which is between 4 and 25 MPa, more preferably between 4.5 and 20 MPa; values of notably between 5 and 15 MPa have proved to be particularly suitable for the reinforcement and the endurance of tyres, in particular the belts thereof. Modulus measurements are made under tension, unless indicated otherwise in accordance with the ASTM D 412 standard of 1998 (test specimen “C”): the “true” secant modulus (that is to say the one with respect to the actual cross section of the test specimen) is measured in second elongation (that is to say after an accommodation cycle) at 10% elongation, expressed in MPa (under standard temperature and relative humidity conditions in accordance with the ASTM D 1349 standard of 1999).

The tyre of the invention, reinforced by the above-described band or (metal/rubber) composite, is intended for all types of vehicles, in particular passenger vehicles or industrial vehicles such as heavy-duty vehicles, civil engineering vehicles, aircraft and other transport or handling vehicles.

By way of example, the appended FIG. 2 very schematically shows (without observing a specific scale) a radial section through a tyre, which is or is not in accordance with the invention in this general depiction, intended for example for a heavy-duty vehicle or a passenger vehicle.

This tyre 100, defining three perpendicular directions, circumferential (X), axial (Y) and radial (Z), comprises a crown 101 reinforced by a crown reinforcement or belt 102, two flexible sidewalls 103 and two inextensible beads 104 intended to be in contact with a mounting rim, the two sidewalls being reinforced by a carcass reinforcement 106, each of the beads 104 being reinforced by a bead wire 105. The crown 102 is surmounted by a tread (not shown in this schematic figure, for simplification). The carcass reinforcement 106 is wound around the two bead wires 105 in each bead 104, the turn-up 107 of this reinforcement 106 being, for example, disposed towards the outside of the tyre 100, which is shown mounted on its wheel rim 108 here. Of course, this tyre 100 also comprises, in a known manner, a layer of rubber 109 commonly referred to as an airtight rubber or layer, which defines the radially inner face of the tyre and which is intended to protect the carcass ply from the diffusion of air originating from the space inside the tyre.

The carcass reinforcement 106 is generally made up of at least one rubber ply reinforced by what are referred to as “radial” textile or metal reinforcers, that is to say that these reinforcers are disposed virtually parallel to one another and extend from one bead to the other so as to form an angle of between 80° and 90° with the median circumferential plane (plane perpendicular to the axis of rotation of the tyre, which is situated mid-way between the two beads 104 and passes through the middle of the crown reinforcement 102).

The belt 102 is, for example, made up of at least two superimposed and crossed “working plies” which are reinforced with metal reinforcers disposed substantially parallel to one another and inclined with respect to the median circumferential plane, it being possible for these working plies to be combined or not combined with other rubber plies and/or fabrics. The belt 102 may also comprise, in this example, a rubber ply referred to as a “hooping ply”, which is reinforced by what are referred to as “circumferential” reinforcing threads, that is to say that these reinforcing threads are arranged virtually parallel to one another and extend substantially circumferentially around the tyre so as to form an angle preferably within a range from 0° to 10° with the median circumferential plane. The function of these circumferential reinforcing threads is notably to withstand the centrifugation of the crown at high speed. The belt 102 may also comprise, in this example, a rubber ply referred to as “protective ply”, generally positioned between the tread and the two crossed working plies.

A preferred feature of a tyre 100, when it is in accordance with the invention, is that at least its belt (102) comprises, as metal reinforcer, the above-described steel band with a very low carbon content, coated in a layer of diene rubber composition, to form at least one (i.e. one or more) belt ply, more preferably at least one belt ply of the working ply type and/or at least one belt ply of the protective ply type.

The use of bands, and thus flat reinforcers, instead of cords or even of single metal threads, makes it possible to increase the reinforcer density in the belt plies. It is thus possible to reduce the thickness of the layer of rubber and of the entire crown of the tyre; thus, the overall weight of the tyre can be further reduced.

In these belt plies, in particular these working plies, the density of the bands is preferably between 5 and 40 bands per dm (decimetre) of ply, more preferably from 10 to 30 bands per dm, the distance (or “pitch”) between two adjacent bands, from centre to centre, thus being preferably between 3 and 20 mm, more preferably from 4 to 7 mm. The bands are preferably disposed such that the width (denoted “Wr” in FIG. 1) of the bridge of rubber, between two adjacent bands, is between 0.5 and 3 mm, more preferably from 0.9 to 1.6 mm. This width “Wr” represents, in a known manner, the difference between the calendering pitch (the pitch at which the band is laid in the rubber fabric) and the width of the band. Below the minimum value indicated, the bridge of rubber, which is too narrow, runs the risk of being mechanically degraded when the ply is working, notably during the deformations undergone in its own plane under extension or shear. Above the maximum indicated, the risk notably arises of objects notably penetrating, by perforation, between the bands, not to mention an undesirable reduction in the mechanical strength of the plies.

According to another embodiment, the composite could be used in the tyre of the invention in the form of thin strips of rubber, with a width that can vary widely depending on the particular applications targeted, for example in the case of belt plies, with a width of around 3 mm to 15 mm, disposed side-by-side, these strips being reinforced by this band and each strip being able to comprise one or more bands disposed in parallel.

According to another possible exemplary embodiment of the invention, it is the carcass reinforcement (106) which can be reinforced with such a band, or even the bead zone; it is, for example, the bead wires (105) which could be composed, entirely or in part, of such a strip.

### 6. EXEMPLARY EMBODIMENTS OF THE INVENTION

Examples of the production of strips and bands will be described below, and also the use of such bands as reinforcers in a tyre belt.

### 6.1. —Production of Strip and Band

For this first test, the starting point was a commercial steel strip with a very low carbon content of the martensitic type (trade name “Docol 1400M” from the company SSAB), the main chemical composition of which was as follows: 0.169% C; 1.17% Mn; 0.23% Si; 0.04% Cr. This starting strip, with a width of 40 cm and a thickness of 0.5 mm, had the following initial mechanical properties: tensile strength (Rm) equal to 1513 MPa, total elongation at break (At) equal to 4%. Its microstructure was thus martensitic.

This strip was work-hardened very greatly through a roller of the “Sendzimir” type with 20 rolls, in six consecutive passes carried out at a speed of 120 m/min, under continuous oil cooling, all this without any intermediate heat treatment regenerating the microstructure between these passes, until a final thickness of around 0.2 mm (or a level of reduction in thickness of 60%) is obtained.

This leads to a work-hardened steel strip, suitable for the invention, with a martensitic microstructure, and having the following mechanical properties: Rm equal to 1925 MPa, At equal to 1%. This strip was then coated with brass (brass with 65.5% copper) by deposition of 115 mg of brass for 100 g of steel. Then, it was sheared into a band with a width equal to 3 mm, a thickness of 0.20 mm and a length of 500 m, which is usable as is as a tyre belt reinforcer.

### 6.2. —Tyre Running Tests (Drift Thrust and Separation Endurance)

The reinforcer thus obtained in the form of a band (denoted R3 below) was then compared both with a conventional control cord (reinforcer denoted R1) for a tyre belt, and with another control band (control reinforcer denoted R2) with a width and thickness identical to those of the band suitable for the tyre of the invention. The two control reinforcers R1 and R2 both being made of steel with a high carbon content (0.8%) and having a conventional microstructure (work-hardened pearlite).

The mechanical properties of the control cord R1 (4 threads of diameter 0.32 mm assembled at a pitch of 1.4 mm) were as follows: Rm equal to 2820 MPa, At equal to 1.5%.

Those of the control band R2 were as follows: Rm equal to 2300 MPa, At equal to 1.6% for a level of reduction in thickness of 87%.

The above three reinforcers (R1, R2, R3) were incorporated, by calendering, between two layers of rubber to form a (metal/rubber) composite based on a known rubber composition to form the belt working plies of heavy-duty tyres. Each of the two rubber layers had a thickness of 0.50 mm for the reinforcer R1 (cord), and half as much (i.e. 0.25 mm) for the reinforcers R2 and R3 (bands).

This composition was based on natural rubber and carbon black as reinforcing filler, also comprising essentially an antioxidant, stearic acid, an extender oil, cobalt naphthenate as adhesion promoter, and finally a vulcanization system (sulfur, accelerator, ZnO); its true secant modulus at 10% elongation was around 10.5 MPa. As a reminder, the adhesion between the bands and the rubber composition coating them was ensured by the prior deposition of the thin layer of brass as described above.

The composite fabrics thus made up of the rubber composition and the bands R1, R2 and R3, respectively, had, for each belt working ply, a total thickness equal to around 1.25 mm for R1, around 0.65 mm for R2 and R3.

The calendering pitch of the bands (the pitch at which the bands are laid in the rubber fabric) was equal to around 3.5 mm (millimetres), the distance “Wr” or width of the bridge of rubber between two consecutive bands (measured in the direction Y) thus being equal to around 0.5 mm. These bands were disposed substantially parallel to one another and inclined at +21 degrees (radially inner ply) and −21 degrees (radially outer ply). All the inclination angles indicated are measured with respect to the median circumferential plane.

The calendering pitch of the cords was equal to around 1.4 mm, the distance “Wr” or width of the bridge of rubber between two consecutive cords (measured in the direction Y) thus being equal to around 0.55 mm. These cords were disposed substantially parallel to one another and inclined at +26 degrees (radially inner ply) and −26 degrees (radially outer ply).

The tyres tested (control and according to the invention, denoted T1, T2, T3, respectively), of dimensions 225/75 R16 “AGILIS”, were tyres for a small heavy-duty vehicle, and of course manufactured identically in all respects apart from the nature of the metal reinforcers (R1, R2 and R3) used for the reinforcement of their belt.

First of all, their drift thrust was measured: each tyre was mounted on a wheel of appropriate size and inflated to nominal pressure. It was run at a constant speed of 80 km/h on a suitable automatic machine (machine of the “flat-track” type sold by the company MTS). The load, denoted “Z”, was varied, at a drift angle of 1 degree, and the cornering stiffness or drift thrust, denoted “D” (corrected for the thrust at zero drift), was measured, in a known manner, by recording, with the aid of sensors, the transverse force on the wheel as a function of this load Z; the drift thrust is the gradient at the origin of the D(Z) curve.

Then, they were subjected to a particularly harsh running test, with an overload, intended to test their resistance to separation (separation of the ends of the crown plies), by subjecting the tyres, on an automatic rolling machine, to sequences of very strong drift and placement of their crown block under strong compression in the shoulder region. The test was run until the forced destruction of the tyres.

The results obtained are summarized in Table 1, the base 100 having been retained for the control tyres (T1) using cords as belt reinforcer. A value of greater than 100 indicates an improved result.

TABLE 1

| | | | |
|---|---|---|---|
| Tyres: | T1 (control) | T2 (control) | T3 (invention) |
| Belt reinforcer: | R1 (control) | R2 (control) | R3 (invention) |
| Content of C (%): | 0.8 | 0.8 | 0.17 |
| Reinforcer | Cord | Band | Band |
| structure: | 4 × 0.32 mm | 0.2 × 3 mm | 0.2 × 3 mm |
| Drift thrust (D) | 100 | 117 | 117 |
| Separation | 100 | 70 | 90 |
| endurance (km) | | | |

On reading this table, it can first of all be seen that the drift thrust (D) in the case of the bands (tyres T2 and T3) is not degraded; it is even improved (+17%) compared with the conventional use of cords, this already being an unexpected result.

Finally, and above all, it will be noted that the replacement of cords (reinforcer R1) with bands translates, in the case of a conventional steel (reinforcer R2) with a high carbon content and a pearlitic microstructure, into a notable loss of separation endurance, around 30%, whereas, surprisingly, the endurance is affected comparatively little, around only 10% in the case of the tyre according to the invention (reinforcer R3) reinforced by the band with a low carbon content and a ferritic-martensitic microstructure.

### 6.3. —Laboratory Tests (Fluctuating Axial Tension)

The endurance of the bands R2 and R3 was also tested in the laboratory. The test known as the “fluctuating axial tension” test is a fatigue test well known to a person skilled in the art (see, for example, applications WO 01/00922 and WO 01/49926), in which the material tested is fatigued in only uniaxial extension (extension-extension), that is to say without any compressive stress. It makes it possible to measure the endurance limit of a given reinforcer, whether this be for example a thread, a cord or a band.

Its principle is as follows: during the test, the reinforcer is subjected to a variation in tension between two extremes defining an amplitude, specifically for a predetermined number of cycles, in this case 10⁵ cycles. If the reinforcer breaks, the test is restarted with a lower amplitude and if the reinforcer does not break, the test is restarted with a higher amplitude. The value of the endurance limit is thus determined step-by-step, for example by the staircase method. This test is carried out under two different conditions: under a dry atmosphere (less than 8% relative humidity) and under a humid atmosphere (60% relative humidity).

For the above conditions and the two types of band, it was possible to determine the endurance limit denoted “T” (under a dry atmosphere without prior storage) and “T*” (under a humid atmosphere without prior storage). Also calculated was the decline, denoted “D*”, in the endurance limit on account of the presence of the humid atmosphere (D*=(T−T*)/T).

The results obtained are given in Table 1 below:

TABLE 2

| Steel band tested: | R2 (control) | R3 (invention) |
|---|---|---|
| Content of C (%) | 0.8 | 0.17 |
| Cross-sectional | 0.2 × 3 mm | 0.2 × 3 mm |
| area of the band | | |
| Rm (MPa) | 2300 | 1925 |
| T (MPa) | 482 | 404 |
| T* (MPa) | 266 | 334 |
| D* | −45% | −17% |

Here too, it will be noted, surprisingly, that the band (R3) with a very low carbon content that is used in the tyre of the invention exhibits much less of a decline, around 2.5 times less, compared with the conventional control steel band (R2) with a high carbon content (0.8%).

This clearly suggests an improved performance in a tyre, in particular under corrosive aging conditions, as confirmed in the following running tests.

### 6.4. —Other Running Tests (Corrosion Fatigue)

All of the degradation processes known under the generic term of corrosion fatigue are the cause, compared with use in a dry atmosphere, of a progressive deterioration in the mechanical properties of the metal reinforcers, in the adhesion thereof to the rubber, and can, for the most severe running conditions, affect the life of said metal reinforcers. Of course, all of that is detrimental to the correct operation of the tyre, in particular of its belt, and ultimately to the performance and overall endurance of the tyre.

The resistance to corrosion fatigue of the tyres T2 (control) and T3 (according to the invention) were evaluated during complementary running tests carried out as explained below.

Before running, two opposite surfaces (around 120×120 mm) of the tread of said tyres were subjected to about fifty perforations (in the radial direction Z) with the aid of a drill bit with a diameter of 4 mm and to a depth greater than 40% of the initial thickness of the tread, in order to encourage the subsequent penetration of a large quantity of moisture into the crown of the tyre while the latter is running.

Then, the tyres thus treated were mounted on a small heavy-duty vehicle of the “Scania” type (R164LB) and made to run at a constant speed of 70 km/h in salt water until they were destroyed by bursting or a loss of pressure.

At the end of this extremely harsh running test, the control tyres had travelled an average of 2500 km, while the tyres of the invention had withstood for 4000 km, i.e. a final increase in endurance of 60% recorded by virtue of the bands with a low carbon content and a specific microstructure.

### 6.5. —Other Laboratory Tests (Fluctuating Axial Tension)

Finally, during new laboratory tests, the endurance under fluctuating axial tension of the above band (R3) was compared with another band (denoted R4) which was also suitable for the invention, this time made of steel with a low carbon content of the dual-phase type and a ferritic-martensitic microstructure (predominantly ferritic) in the work-hardened state.

The band R4 was manufactured as indicated above for the band R3, from a commercial steel strip with a very low carbon content of the dual-phase type (trade name “DP 600” from the company Arcelor) with an initial thickness of about 2 mm, until a final thickness of about 0.2 mm (or a reduction in thickness of 90%) was obtained. The starting strip had the following initial mechanical properties: Rm equal to 650 MPa, At equal to 25%; its main chemical composition was as follows: 0.086% C, 1.49% Mn, 0.26% Si, 0.002% S, 0.02% P; its microstructure was thus ferritic-martensitic of the dual-phase type.

FIG. 3 is an optical microscope view of the ferritic-martensitic microstructure present in the starting strip, and FIG. 4 shows the same ferritic-martensitic microstructure after work-hardening: a ferritic matrix predominantly containing laths of martensite oriented in the work-hardening direction (denoted D) is clearly apparent therefrom.

The results of these endurance tests are summarized in Table 3 below.

TABLE 3

| Steel band: | R3 (invention) | R4 (invention) |
|---|---|---|
| Carbon steel: | MS (martensitic) | DP (dual-phase) |
| Content of C (%): | 0.17 | 0.09 |
| Cross-sectional | 0.2 × 3 mm | 0.2 × 3 mm |
| area of the band: | | |
| Rm (MPa) | 1925 | 1415 |
| T (MPa) | 404 | 360 |
| T* (MPa) | 334 | 360 |
| D* | −17% | −0% |

It can be seen, thus confirming the first results obtained with the band R3, that the band R4 also has excellent endurance, which is even improved compared with the band R3: specifically, under the test conditions, no deterioration in strength Rm was even observed in the band R4 between the conditions under a dry atmosphere and under a humid atmosphere.

In conclusion, as demonstrated by the numerous tests above, the advantages provided by the bands suitable for the tyres of the invention are numerous, with notably improved endurance with regard to separation, and reduced sensitivity to corrosion, compared with tyres using conventional metal reinforcers in the form of cords or even bands with a high carbon content and a pearlitic microstructure.

1.-14. (canceled)

15. A motor vehicle tire comprising at least one carbon steel band that has a very low carbon content and high strength in the work-hardened state,
wherein the carbon steel has between 0.05% and 0.4% by weight of carbon, between 0.5% and 4% by weight of manganese, between 0.1% and 2.5% by weight of silicon, and optionally (i) less than 1.5% by weight of aluminum, (ii) less than 0.5% by weight of each of the metals boron, chromium, cobalt, copper, molybdenum, nickel, niobium, titanium, tungsten, vanadium, and zirconium, and (iii) less than 0.05% by weight of each of the elements phosphorus, sulfur, nitrogen, and rare earth, and the remainder of the carbon steel is made up of iron and impurities resulting from smelting,
wherein the microstructure of the work-hardened carbon steel is mainly martensitic or ferritic-martensitic; and
wherein the strength Rm of the band is greater than 1200 MPa and the elongation at break At is between 1% and 5%.

16. The motor vehicle tire according to claim 15, wherein the carbon content of the carbon steel is in a range from 0.1 to 0.3%.

17. The motor vehicle tire according to claim 15, wherein the manganese content of the carbon steel is in a range from 1% to 3%.

18. The motor vehicle tire according to claim 15, wherein the silicon content of the carbon steel is between 0.1 and 1.5%.

19. The motor vehicle tire according to claim 15, wherein the optional aluminum content of the carbon steel is less than 1.0%.

20. The motor vehicle tire according to claim 15, wherein the content of each of the optional metals boron, chromium, cobalt, copper, molybdenum, nickel, niobium, titanium, tungsten, vanadium, and zirconium is less than 0.3%.

21. The motor vehicle tire according to claim 15, wherein the carbon steel is a TRIP steel within the meaning of the NF EN 10338 (October 2015) standard.

22. The motor vehicle tire according to claim 15, wherein the carbon steel is a dual-phase steel within the meaning of the NF EN 10338 (October 2015) standard.

23. The motor vehicle tire according to claim 15, wherein the carbon steel is a martensitic steel within the meaning of the NF EN 10338 (October 2015) standard.

24. The motor vehicle tire according to claim 15, wherein the strength Rm of the band is greater than 1500 MPa.

25. The motor vehicle tire according to claim 15, where the elongation At of the band is between 1% and 3%.

26. The motor vehicle tire according to claim 15, wherein the thickness of the band is between 0.1 and 0.8 mm.

27. The motor vehicle tire according to claim 15, wherein the width of the band is between 1 and 15 mm.

28. The motor vehicle tire according to claim 15, wherein the band is present in the belt of the tire.

29. The motor vehicle tire according to claim 16, wherein the carbon content of the carbon steel is in a range from 0.15 to 0.25%.

30. The motor vehicle tire according to claim 17, wherein the manganese content of the carbon steel is in a range from 1.5 to 2.5%.

31. The motor vehicle tire according to claim 18, wherein the silicon content of the carbon steel is between 0.2 to 1.0%.

32. The motor vehicle tire according to claim 19, wherein the optional aluminum content of the carbon steel is less than 0.5%.

33. The motor vehicle tire according to claim 20, wherein the content of each of the optional metals boron, chromium, cobalt, copper, molybdenum, nickel, niobium, titanium, tungsten, vanadium, and zirconium in the carbon steel is less than 0.2%.

34. The motor vehicle tire according to claim 24, wherein the strength Rm of the band is greater than 1800 MPa.

35. The motor vehicle tire according to claim 25, wherein the elongation At of the band is between 1.5% to 2.5%.

36. The motor vehicle tire according to claim 26, wherein the thickness of the band is between 0.2 to 0.5 mm.

37. The motor vehicle tire according to claim 27, wherein the width of the band is between 2.5 to 10 mm.
